(19) United States
(12) Patent Application Publication
(10) Pub. No.: US 2013/0130865 A1
(43) Pub. Date: May 23, 2013

(54) Bi-Axial Rolling Continuously Variable Transmission

(71) Applicants: Jared Leidich, Golden, CO (US); Andrew Stephen Tomchek, Boulder, CO (US); Colin Aaron Miller, Boulder, CO (US)

(72) Inventors: Jared Leidich, Golden, CO (US); Andrew Stephen Tomchek, Boulder, CO (US); Colin Aaron Miller, Boulder, CO (US)

(21) Appl. No.: 13/681,064

(22) Filed: Nov. 19, 2012

Related U.S. Application Data
(60) Provisional application No. 61/629,314, filed on Nov. 17, 2011.

(51) Int. Cl. F16H 15/44; F16H 15/28

(52) U.S. Cl. CPC F16H 15/44; F16H 15/28
USPC 476/55

(57) ABSTRACT

Continuously variable transmissions are provided. Various systems provide for co-rotating power transmission or drive members for conveying angular velocity and torque from an input, such as an engine or motor, to an output, such as a drive shaft. Angular velocity and torque input-output ratios are varied by user manipulation of at least one of the power transmission members and resulting change in orientation of curvilinear power transmission members.

The present application claims priority from U.S. Provisional Patent Application 61/629,314, filed Nov. 17, 2011, the entire disclosure of which is incorporated by reference herein.

### FIELD

The present disclosure relates generally to transmission systems. More specifically, the present disclosure relates to infinitely or continuously variable transmission systems for transmitting power between an input source and an output.

### BACKGROUND

In the past, various types of transmission, both mechanical and hydraulic have been developed and used that include a clutch mechanism. Such prior art devices are of a complicated structure, and require careful maintenance to remain in a satisfactory operating condition.

In order to provide a continuously variable transmission, various traction roller transmissions that transmit power through traction rollers supported in a housing between torque input and output discs have been developed. In such transmissions, the traction rollers are mounted on support structures which, when pivoted, cause the engagement of traction rollers with the torque discs in circles of varying diameters depending on the desired transmission ratio.

The use of a driving hub for a vehicle with a variable adjustable transmission ratio is known. In some instances a transmission uses iris plates to tilt the axis of rotation of the rollers. Other transmissions include a shaft about which an input disc and an output disc rotate. The input and output discs mount on the shaft and contact balls are disposed equidistantly and radially about the shaft. The balls are in frictional contact with both discs and transmit power from the input disc to the output disc. An idler located concentrically over the shaft and between the balls aids in maintaining frictional contact between the balls and the input and output discs.

### SUMMARY

In various embodiments, a variable ratio transmission system is provided. The system is designed to incorporate simple mechanical elements to provide an infinitely variable ratio transmission, for use in various devices, environments, and conditions.

An object of the present invention is to provide a variable ratio transmission in accordance that conforms to conventional forms of manufacture, is of simple construction and provides a user-friendly device that is economically feasible to manufacture, long lasting and relatively trouble free in operation.

Another object of the present invention is to provide a mechanical transmission that has a relatively simple structure, requires a minimum of maintenance attention, and by pivotal movement of a control shaft the ratio of angular velocity or torque between the input and output of the system may be readily altered without necessitating the need to slip.

In various embodiments, the present invention provides a bi-axial rolling continuously variable transmission (hereafter “BAR CVT”). It will be recognized that BAR CVT may also be referred to as infinitely variable transmission, or similar terms of art, and no limitation is implied by this term(s). Embodiments contemplate rotary motion on at least two axes to create a continual variability in a power transmission system.

In various embodiments, an input and an output shaft are provided. The input and output shafts are preferably reversible. In such embodiments, the CVT may be considered bi-axial in that the power transfer system utilizes rotation about two axes at a time, with various power transmission features as shown and described herein provided therebetween.

One embodiment of the present invention comprises a sphere/cylinder arrangement, as will be described in more detail.

As used herein, the term “ratio” or “gear ratio” refer to the ratio between an input angular velocity and an output angular velocity translating power or torque. The term “gear ratio” is thus not limited to, nor does it imply the physical implementation of any type of “gear.” Various embodiments of the present disclosure contemplate the lack of any convention toothed gear or a discrete set of gears. Nevertheless, the general concept of “gear ratio” applies in a CVT-sense and as will be described in more detail herein.

In various embodiments, the present disclosure contemplates transmitting power and rotational motion through at least two bodies. The bodies are provided in contact with one another, and both rotate about an axis. At a specific gear ratio, the bodies can be viewed as contacting each other along respective circumferences. The respective circumferences may vary as the bodies co-rotate, thus altering the ratio in a continuously-variable manner. Where spherical or substantially spherical bodies are provided, an exponential range of ratios is provided, corresponding to the surface contour of the sphere and the non-linear increase of the sphere's circumference (e.g. as opposed to a cone which may be considered to have a linear change in circumference).

Various embodiments of the present disclosure contemplate Sphere-Sphere CVTs. Sphere-Sphere CVTs according to various embodiments comprise at least two substantially spherical or hemi-spherical transmission bodies in power-transmitting contact with one another. Rotation of at least one body about a substantially vertical axis alters the contact point, which corresponds to a circumference when revolved, and changes gear ratio. Where both bodies are rotated about this axis at the same angular velocity, the system transfers power in a dynamically determinate fashion (i.e. nothing needs to slip in order for the system to function and therefor all input and output variables are known) which greatly reduces wear in the system. Such rotation and change occurs in a linear fashion in the Sphere-Sphere CVT embodiments. The system is essentially mirrored across a center-line, producing a relatively simplistic, low-cost, low-maintenance system.

One embodiment of the present disclosure comprises a Sphere-Cylinder CVT. Sphere-Cylinder CVTs provide for changing rates of change for the gear ratio output. Toward the nose of the sphere or edge of the cylinder, rotation of a power transmission feature alters gear ratios at a faster rate than at other portions of the sphere or cylinder.

Further embodiments of the present disclosure comprise Cylinder-Cylinder-Sphere CVTs, wherein at least two substantially cylindrical power transmission bodies are provided in contact with at least one substantially spherical transmission body.

Even further embodiments of the present disclosure comprise Sphere-Sphere-Cylinder CVTs. Such embodiments comprise at least two substantially spherical power transmission bodies and at least two substantially spherical or hemispherical power transfer bodies, and at least one substantially cylindrical power transfer body.

In one embodiment, a CVT is provided, the CVT comprising a first rotary power transfer member for receiving an input power from an input, the first power transfer member being rotated about a first axis by the input power, a second rotary power transfer member for receiving power from the first rotary power transfer member and transmitting the power to an output, the first rotary power transfer member and second rotary power transfer member being in frictional torque-transmitting contact with one another, and wherein an angular velocity of the output varies from an angular velocity of the input as a function of the orientation of the first power transfer member with respect to the second power transfer member, and wherein the first power transfer member is rotatable about a second axis, the second axis being substantially perpendicular to the first axis.

In preferred embodiments, the first axis and the second axis intersect substantially at a center point of a power transfer member or sphere. This point may be considered the dynamic center of the power transfer joint.

Embodiments of the present invention are useful in various applications. Such applications include, but are not limited to, power transmission systems for: powered vehicles such as automobiles, motorcycles, and variations thereof; trains, or variations thereof; bicycles; power generation device(s), such as turbines, generators or other power generation and/or conversion mechanisms; machining mechanisms, such as cutting tools or various rotary tools; pumps; well and mineral drilling operations and devices; propellers; centrifuges; mixers; balancers; gyroscopes; washing machines and dryers; blenders; sewing machines; electric and gas motors; etc.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended and can be used interchangeably herein.

The terms “first” and “second,” as used herein, are not intended to connote importance or priority, but are used to distinguish one feature from another.

The term “automatic” and variations thereof, as used herein, refers to any process or operation done without material human input when the process or operation is performed. For example, a stop may be provided that automatically resets to a predetermined position without human assistance or intervention.

It shall be understood that the term “means,” as used herein, shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the claimed subject matter is intended by either the inclusion or non-inclusion of elements, components, etc. in this Summary. Moreover, reference made herein to “the present invention” or aspects thereof should be understood to mean certain embodiments of the present disclosure and should not necessarily be construed as limiting all embodiments to a particular description. The above and other objects advantages and features will become more readily understood from a consideration of the following detailed description when taken together with the accompanying drawings.

### BRIEF DESCRIPTION OF THE DRAWINGS

The accompanying drawings, which are incorporated in and constitute a part of the specification, illustrate embodiments of the disclosure and together with the general description given above and the detailed description of the drawings given below, serve to explain the principles of these embodiments.

FIG. 1 is a top plan view of a CVT system comprising a sphere-cylinder arrangement in accordance with one embodiment of the present disclosure;

FIG. 2 is a top plan view of a CVT system comprising a sphere-sphere arrangement in accordance with one embodiment of the present disclosure;

FIG. 3 is an elevation view of a CVT system comprising a sphere-sphere arrangement in accordance with one embodiment of the present disclosure;

FIG. 4 is front perspective view of a CVT system comprising a cylinder-cylinder arrangement in accordance with one embodiment of the present disclosure;

FIG. 5 is front perspective view of a CVT system comprising a cylinder-sphere-cylinder arrangement in accordance with one embodiment of the present disclosure;

FIG. 6 is a perspective view of a component of a CVT system in accordance with one embodiment of the present disclosure;

FIG. 7 is a perspective view of a component of a CVT system in accordance with one embodiment of the present disclosure;

FIG. 8 is a side elevation view of a CVT system incorporated into a larger system as contemplated by one embodiment of the present disclosure;

FIG. 9 is a partially exploded perspective view of one embodiment of the present disclosure;

FIG. 10 is a perspective view of power transfer bodies according to one embodiment of the present disclosure;

FIG. 11 is a top plan view of a power transfer body according to one embodiment of the present disclosure;

FIG. 12 is a top plan view of a power transfer body according to one embodiment of the present disclosure; and

FIG. 13 is a perspective view of a power transfer body according to one embodiment of the present disclosure.

It should be understood that the drawings are not necessarily to scale. In certain instances, details that are not necessary for an understanding of the disclosure or that render other details difficult to perceive may have been omitted. It should be understood that the claimed subject matter is not necessarily limited to the particular embodiments illustrated herein.

To assist in the understanding of the drawings, the following is a list of components and associated numbering found in the drawings:

| Component | |
|---|---|
| Number | Name |
| 1 | Input power shaft |
| 2 | Input power transfer body |
| 3 | Gear ratio change interface |
| 4 | Output power transfer body |
| 5 | Output power shaft |
| 6 | Output stabilizer bearing |
| 7 | Output stabilizer shaft |
| 8 | Static universal joint |
| 9 | Power transfer joint |
| 10 | Output stabilizer bearing |
| 11 | Linear drive bearing |
| 12 | Input shaft stabilizer bearing |
| 13 | Bracing structure |
| 14 | Bracing structure bearing |
| 15 | Input shaft stabilizer bearing |
| 16 | Main bearing |
| 17 | Input side bracing structure |
| 18 | Input stabilizer bearing |
| 19 | Input power shaft |
| 20 | Power transfer joint |
| 21 | Main bearing |
| 22 | Control casing |
| 23 | Input power transfer body |
| 24 | Bracing structure bearing |
| 25 | Output power transfer body |
| 26 | Output main bearing |
| 27 | Output power transfer joint |
| 28 | Bracing structure |
| 29 | Output shaft |
| 30 | Output side bracing structure |
| | bearing |
| 31 | Output side collar |
| 32 | Output stabilizer bearing |
| 33 | Output side bracing structure |
| 34 | Output stabilizer bearing |
| 35 | Stabilizer arm top |
| 36 | Stabilizer arm bottom |
| 37 | Stabilizer brace post |
| 38 | Power transfer body |
| 39 | U-joint |
| 40 | Power transfer body |
| 41 | Power transfer surface |
| 42 | Stabilizer arm |
| 43 | Control linkage |
| 44 | Power transfer body |
| 45 | Fermat spiral contact pattern |
| | spline |
| 46 | Extruded format spiral |
| | contact pattern spline |
| 48 | Sphere-Sphere CVT |
| 49 | Power source |
| 50 | Wheel |
| 51 | Input power shaft |
| 52 | Gear ratio change interface |
| 53 | Output shaft |
| 54 | Gear changing axis |
| 55 | Power transfer axis |
| 56 | Output rotational direction |
| 57 | Input power direction |
| 58 | Gear ratio change direction |
| 59 | Shifter movement direction |
| 60 | Power transfer body |
| 62 | Splined shaft |
| 70 | Linear bearing |
| 72 | Power transfer body |
| 74 | Power transfer body |
| 76 | Projection |
| 78 | Projection path |
| 80 | Power transfer body |
| 82 | Surface texture |

### DETAILED DESCRIPTION

Although some embodiments will now be described with reference to the drawings, it should be understood that the embodiments shown are by way of example only and are merely illustrative of some of the many possible specific embodiments which can represent applications of the principles of the disclosure. Various changes and modifications, obvious to one skilled in the art to which the claimed subject matter pertains, are deemed to be within the spirit, scope and contemplation of the disclosure as further defined in the appended claims.

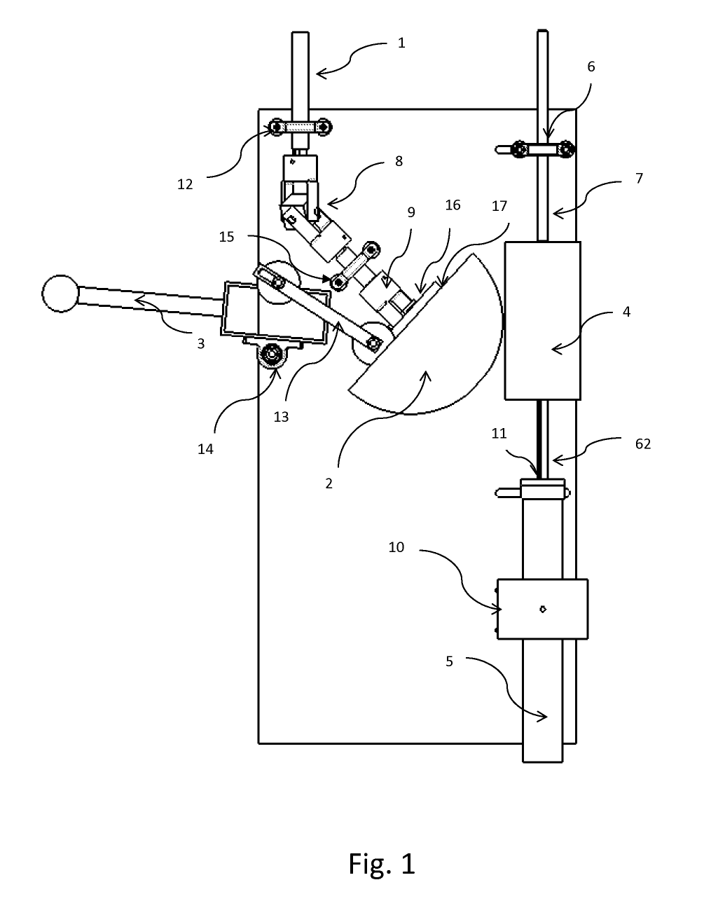

FIG. 1 depicts one embodiment of a CVT hereafter referred to as a Sphere-Cylinder CVT. FIG. 1 depicts a device where power and/or kinetic energy is transferred from a hemispherical structure 2 to a substantially cylindrical structure 4. Accordingly, it will be recognized that Sphere-Cylinder CVT embodiments comprise device including hemispherical devices, and not limited to purely or fully-spherical arrangements.

As shown, a power transfer point or contact patch is provided at the intersection of the spherical portion 2 and the substantially cylindrical portion 4. A power shaft 1 is provided and stabilized by a control bearing 12 or other mechanism capable of stabilizing a rotating shaft. In various embodiments, the input shaft 1 comprises a universal joint 8 to turn a drive mechanism 2. The power transfer shaft 1 is further stabilized by a control bearing 15 or other similar mechanism capable of stabilizing a rotating shaft. The shaft is further coupled to a power transfer joint, which comprises a universal joint 9 in various embodiments. This universal joint 9 could be any mechanism allowing rotary power to be transferred at changing angles such as a CVC joint, a geared U-joint, or a flexible driveshaft. The universal joint 9is coupled to the spherical power transfer body 2. Coupling of power transfer bodies as shown and described herein to various additional system components may be accomplished by a variety of known means, including, for example, set screws, adhesives, rivets, welds, and various combinations thereof.

The power transfer body 2 may also be coupled to a main bearing 16, thus allowing the power transfer body 2 to rotate while the outer casing of the main bearing 16 remains substantially fixed. The outer casing of the main bearing 16 may be coupled to a control linkage mechanism. The control linkage mechanism comprises a control casing 17 which may be comprised of any hard material and may be of any geometry to mate with the outer casing of the main bearing 16. The control casing 17 is coupled to a control linkage 13, or any mechanism capable of restricting motion of the control casing to two dimensions. The control linkages may couple to a set point post 14 through a bracket. The function of the control linkage mechanism is to restrict motion of the power transfer body to two dimensions, and also to create an interface point for changing the angular velocity ratio between the input 2 and output 4 of the system using any automated or manual mechanism such as a handle 3. Preferably, and as shown in FIG. 1 the two functions of stabilizing the power transfer body/bodies and changing the angular velocity ratio are performed by the same mechanism.

Control linkage 13 and gear ratio change interface 3 are operable to alter the orientation of the power input transfer body 2 and thus alter the circumference of the sphere 2 contacting the substantially cylindrical structure 4 on an output side of the system. Higher gear ratios are achieved where the input body 2 is contacting the substantially cylindrical structure 4 at a larger circumference, and lower gear ratios are achieved where the input body 2 is contacting the substantially cylindrical structure 4 at a smaller circumference (e.g. toward the nose of the body 2).

A first power transfer body 2 transfers power to the second power transfer body 4 across a contact point, contact patch, mesh interface, frictional interface, or any other mechanism capable of transferring power/rotation between two surfaces of the bodies 2, 4. In the embodiment shown in FIG. 1, the second power transfer body 4 is generally restricted to linear and rotational motion. A linear/rotary bearing 6 secures an output shaft 7 on one side. The other side of the power transfer body 4 or output shaft may be comprised of an assembly for converting a direction of motion or rotation.

A universal joint 8 is provided to accommodate rotation of the first power transfer body 2 about an axis, while transmitting or providing rotational power to the body 2. A linear drive bearing 11 is provided to stabilize various components and allow delivery of power to an output shaft 5. Additionally, an output stabilizer bearing 10 may be provided to provide for additional stabilization. It will be recognized, however, that the present invention is not limited to these components, or any particular arrangement thereof A splined shaft 62 and spline shaft bearing 11 provides support to the power transfer body 4, and allows the power transfer mechanism 4 to move linearly while transferring rotary power to a spline shaft bearing 11. The rotary power may be transferred through a tube supported by a mounted bearing 10 or any mechanism capable of allowing rotary motion while supporting a shaft. This allows a static power output/input point 5.

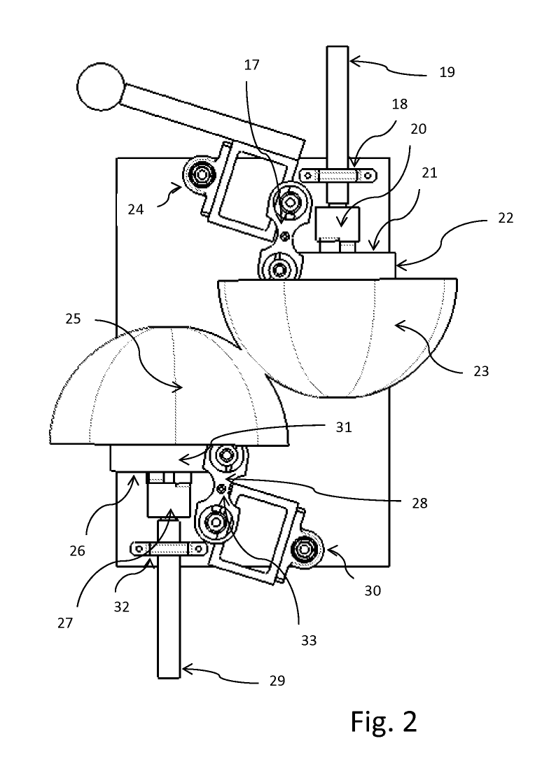

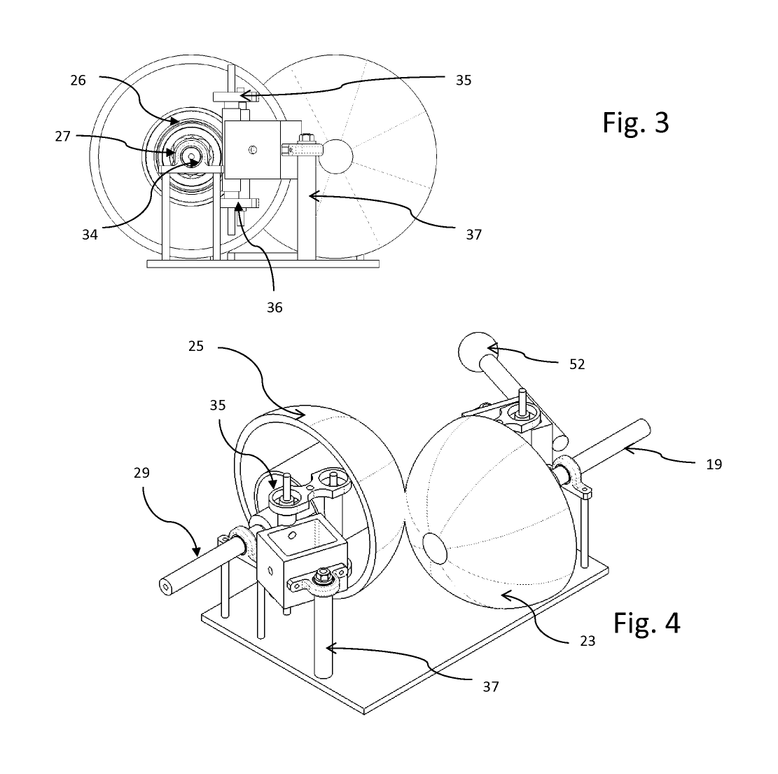

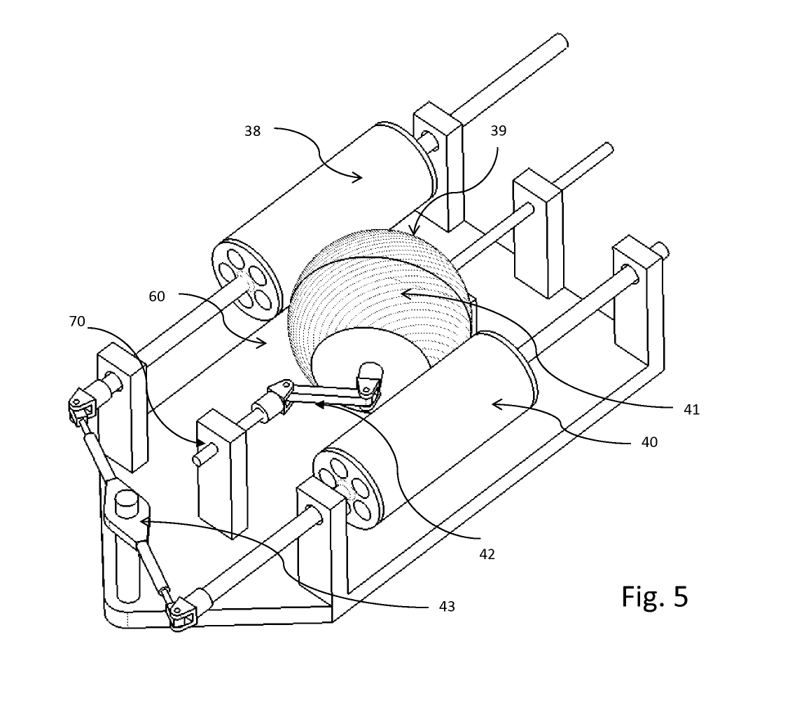

FIGS. 2-4 depict one embodiment of the present invention, hereafter referred to as a Sphere-Sphere CVT. In this embodiment, a power input shaft 19 is stabilized by a power input bearing 18. The shaft 19 is coupled to a power transfer joint, which may comprise a universal joint 20. The universal joint 20 is further coupled to a power transfer body 23, as will be described in more detail herein. The power transfer body 23 may also be coupled to a main bearing 21, allowing the power transfer body 23 to rotate while the outer casing of the main bearing 21 does not. The outer casing of the main bearing 21 is coupled to a control linkage mechanism. The control linkage mechanism comprises a control casing 22 which may be comprised of any hard material and may be of any geometry to mate with the outer casing of the main bearing 21. The control casing 22 is coupled to control linkages 17 or any mechanism capable of restricting motion of the control casing to two dimensions. The control linkages couple to a set point post 24 through a bracket. The control linkage 17 restricts motion of the power transfer body to two dimensions, and also creates an interface point for changing the angular velocity ratio between the input and outputs of the system, these two functions do not need to be performed by the same mechanism, but it is preferable that they are.

A first power transfer body 23 transfers power to a second power transfer body 25 via a contact point, contact patch, mesh interface or quasi frictional interface. Frictional force, normal force, or various combinations and variations thereof provide for transfer of power in the form of kinetic energy from a first body 23 to a second body 25. Second power transfer body 25 is provided for transferring power from first transfer body 23 to output shaft 29. Second power transfer body 25 comprises similar associated components as aforementioned first power transfer body 23 mirrored across a centerline. For example, in the depicted embodiment, second power transfer body 25 is associated with output side collar 31, output side power transfer joint 32, output side bracing structure 33, and output stabilizer bearing 34.

Additionally one of the control linkage mechanisms can be adapted to include the mechanism to change the gear ratio. A simple interface may be a handle, but could include any shifter mechanism, automated or not.

Various embodiments of the present invention comprise three power transfer bodies. Specifically, various embodiments are contemplated that comprise a pair of power-transfer cylinders and a power transfer sphere. Such embodiments are hereafter referred to as a Cylinder-Cylinder-Sphere style BAR CVTs. In one particular embodiment, and as shown in FIG. 5, a power transfer interface is at least one of two cylindrical bodies 38, 40 in contact with a spherical body surface 60. Power is transferred through a power input side to a substantially spherical power transfer body 60 which is attached via a universal joint or other mechanism to transfer power at varying angles of input such as a CVC joint geared U-joint or flexible driveshaft 39. When one of power transfer bodies 38, 40 move in a linear direction, the inverse axial motion linkage 43 will cause the other body 38, 40 to move in the opposite direction, thus rotating the substantially spherical power transfer body 60 and changing the radius at which the power transfer contact points are applied and continually varying the gear ratio. The substantially spherical power transfer body 60 is constrained from motion about at least one axis using a stabilization linkage 42 comprising hinges and a linear bearing 70 or any other mechanism capable of restricting the motion of the spherical body to two dimensions (excluding axial rotation). The power input (or output) shaft connects to the U joint 39 to provide power to the system at the substantially spherical power transfer body 41. The power is transferred at the power transfer contact points to the cylinders bounding the sphere (38 and 40) the power output shaft can be from one or both of the cylinders, by extracting power from both cylinders the torque capability of the transmission is doubled for any configuration.

The power transfer bodies used in this invention may include several features and varying geometries. In some embodiments of the present invention, an interface utilizing high friction surfaces of the same type or different mating types on any two contacting power transfer bodies are provided. These surfaces may include a compliant surface like rubber and or a hard surface such as a metal or plastic. These surfaces could also include a high pressure high friction material like a compound organic resin or ceramic material such as materials typically used in clutch and/or brake pads.

In various embodiments, a mechanically textured surface is provided on power transfer bodies, wherein small ribs or surface textures create a quasi-static interface with a compliant material (e.g. rubber) and/or an inversely patterned mechanically textured surface to additionally increase torque. Ribs of the present disclosure can be any size. Preferably, however, ribs are provided with a 0.01 to 0.1 inch width and equivalent height for a power transfer body less than approximately 8 inches in diameter.

In certain embodiments, one power transfer body comprises a mechanically textured surface and the other includes a surface comprised of a compliant material or any material mating with the mechanically textured surface to transfer power.

In various embodiments, a spherical or near spherical power transfer body comprises unique spline geometry to create a solid mesh with another power transfer body. By twisting a body (mathematically or using a solid modeling software program) with any number of vertical splines running from the top pole of the hemisphere to the equatorial edge of the hemisphere (for a full hemisphere this should result in the spline meeting the equator of the sphere perpendicular to the bottom face) at approximately 137.508 degrees (commonly referred to as “the golden angle” in mathematics, this makes what is known commonly as “fermat's spiral” projected onto a spherical surface), the resulting body will have equidistant splines running from where the spline leaves the bottom surface of the hemisphere to the point on the spherical face where the boundary effects of the surface cause the splines to depart from being equidistant (this depends on the specific geometry of the hemisphere). The term “equidistant” as used herein refers to a set of splines in which a tangent line of one spline and a tangent line of either adjacent spline to it when parallel are the same distance apart at the point at which they are tangent across the length of the spline.

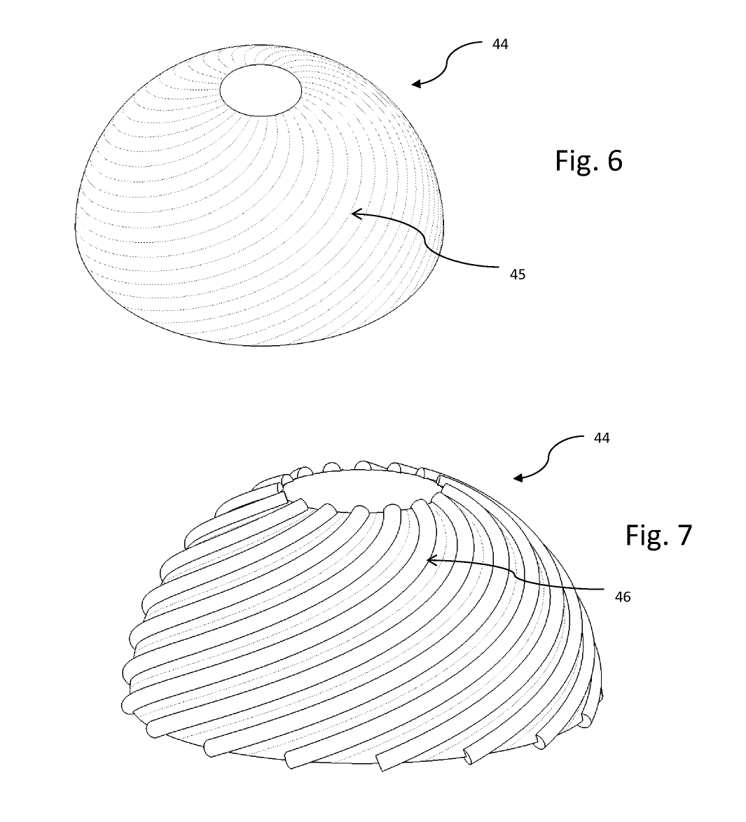

FIG. 6 depicts one embodiment of an equidistant spiral mesh spline 45 provided on a power transfer body 44. Any method of creating equidistant splines could be employed including a modeling approach, a mathematical equation driven approach, an empirical or trial based approach, or any other method of creating splines that are equidistant. If a spline crossectional profile were swept along the length of the spline as shown in these swept elements could mesh with a mating equidistant geometry on a mating power transfer body to create a rigid mesh.

FIG. 7 depicts one embodiment of a substantially spherical power transfer body 44 with surface features 46. As shown in FIG. 7, the swept geometries are 0.15 radius half-circles swept across the spiral geometry described herein on an 6 inch diameter hemisphere and equally spaced to make 16 splines (one spline per 22.5 degrees) with a resulting spacing of about 0.3 inches (equal to that of the diameters of the splines)

In a purely frictional Sphere-Sphere CVT embodiment of the current invention with approximately 6 inch diameter power transfer bodies, at least 400 ft.-lbs of torque is capable of being transferred without risk of slip or yielding in the power transfer bodies. For example, one embodiment contemplates a steel-steel contact surfaces with a recognized static friction coefficient of approximately 0.8, and a power transfer point acting at approximately 3 inches from the axis of rotation. In such an embodiment, 400 ft.-lbs of torque could be transferred between power transfer bodies and through the transmission system. Using Hertzian mechanics, the shear forces can be found and used to verify that the power transfer-body materials will not yield in shear at the contact point. In the foregoing example, the shear strength of the system exceeds the theoretical maximum shear by a safety factor greater than 115, and the risk of shear failure or slip is very low. Materials with high coefficient of friction, shear and compressive strength are contemplated to transfer power at high torque.

Various embodiments of the present disclosure rely upon frictional force(s), normal force(s), and various combinations thereof. As used herein, the term “friction” or “frictional” is not to be construed as limiting, but generally refers to the presence of at least some friction force in a transmission system. Accordingly, embodiments referred to and described as frictional should not be read as excluding the presence of or reliance upon power transfer via a normal force (or component thereof) between two or features of the system.

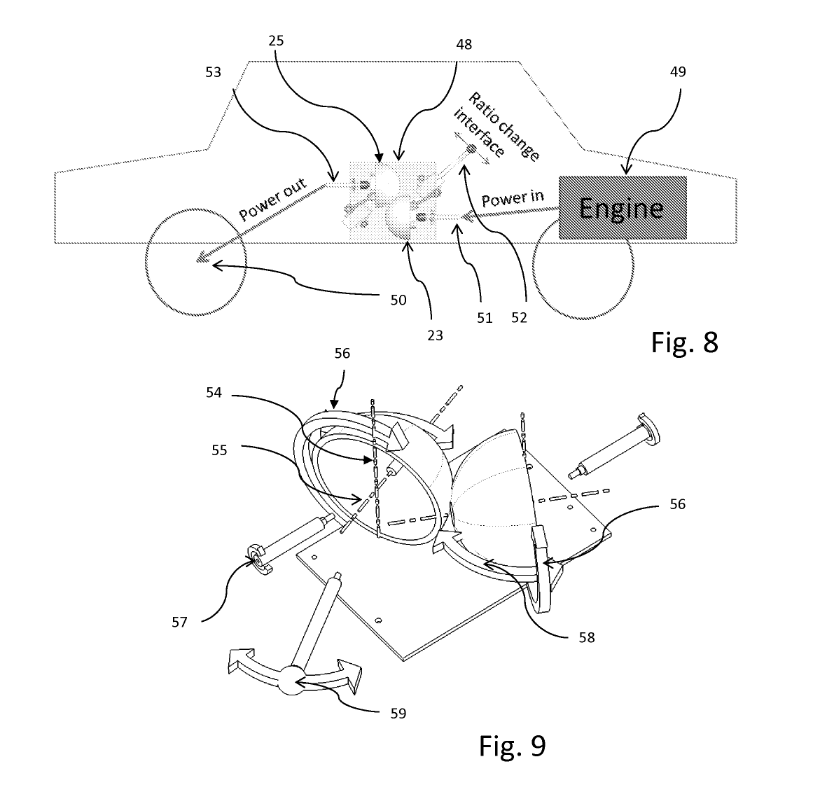

FIG. 8 depicts a CVT according to one embodiment and wherein a transmission 48 is coupled with a power source 49, such as an internal combustion engine, delivering power and/or kinetic energy via an input shaft 51. The transmission 48 provides for power transmission through output 53, which delivers rotary power to any device necessitating power, such as wheels 50 of a car or similar vehicle. In this embodiment, the ratio change interface 52 is operable to change an angular velocity of the input power source 51 with respect to the output power source 53. This change in ratio between angular velocity of input and output rotational speed (and subsequently torque) may be executed continuously, thus providing an infinite number of “gear ratios” between the lower and upper bounds of the system (for which there could be any, depending on overall size). Various embodiments of CVTs as shown and described herein could be implemented in a similar fashion, vehicle, etc.

As shown in FIG. 9, a power rotation axis 55 is the axis about which power is transmitted and a ratio variation axis 54 is the axis about which the power transfer body rotates to create continual variability. Rotational motion 56 about first axis 55 is indicated, as well as rotational motion 58 about a second axis 54. Rotation 58 about second axis 54 creates variability in rotation rate (angular velocity) between the power input and output. Moving the ratio transfer interface 59 (hereafter referred to as a “shifter”) changes the ratio of angular velocity between the input and output side (hereafter referred to as the “gear ratio”). In the depicted embodiment, a first hemisphere 23 is rotatable about two axes while maintaining constant or near constant contact with a second hemisphere 25. First hemisphere 23 rotates about a power transfer axis 55 from the application of power and transfers power to the other hemisphere at the contact point, patch, meshing interface or other power transfer contact mechanism. When rotated about the ratio variation axis 54, the radius of the circle (or other length of a varying geometry) which is in contact will vary between the hemispheres creating a different gear ratio depending on the angle at which one power transfer body is in relation to the other power transfer body.

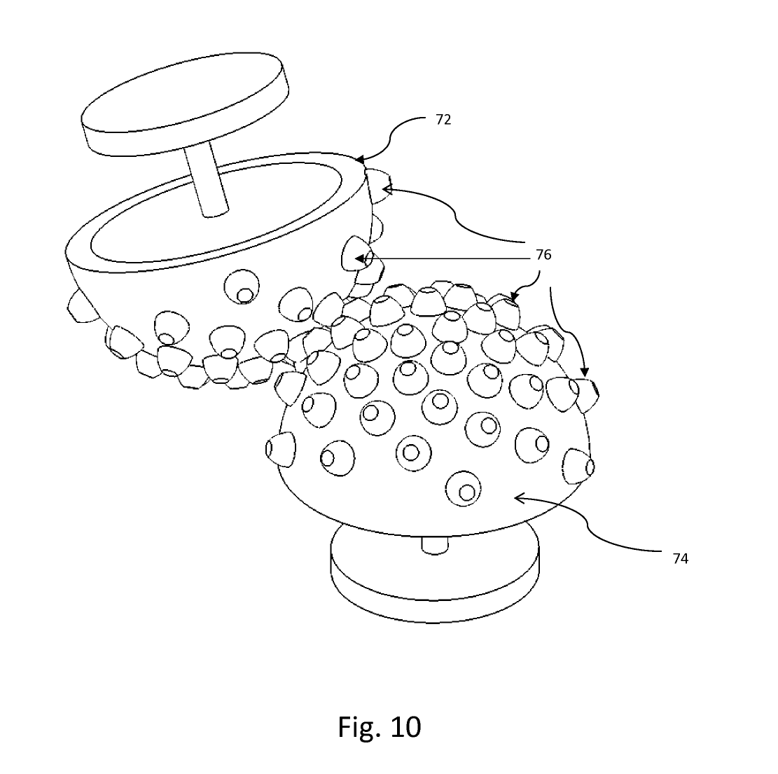

In various embodiments a pattern or array of discrete projections or knobs are provided on outer surface of at least one transfer body. FIG. 10 is a perspective view of complementary power transfer bodies 72, 74 of spherical construction, and more specifically hemispherical construction, each of the power transfer bodies 72, 74 being of approximately the same dimensions. Provided on the outer surface of each power transfer body 72, 74 is an array of projections 76. Projections provided on a first power transfer body 72 engage and transfer power to a second power transfer body 74. In such embodiments, power transfer is aided or enhanced by application of a normal force between at least two projections 76, which may be in addition to or in lieu or application of a frictional force transferring power between bodies 72, 74.

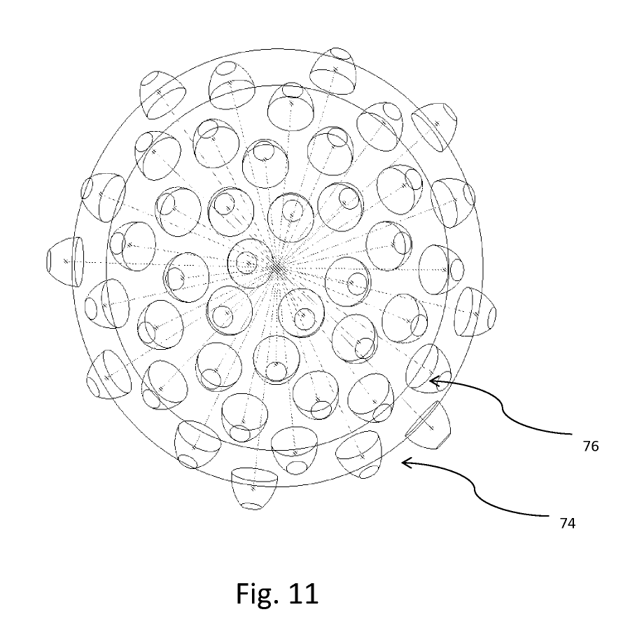

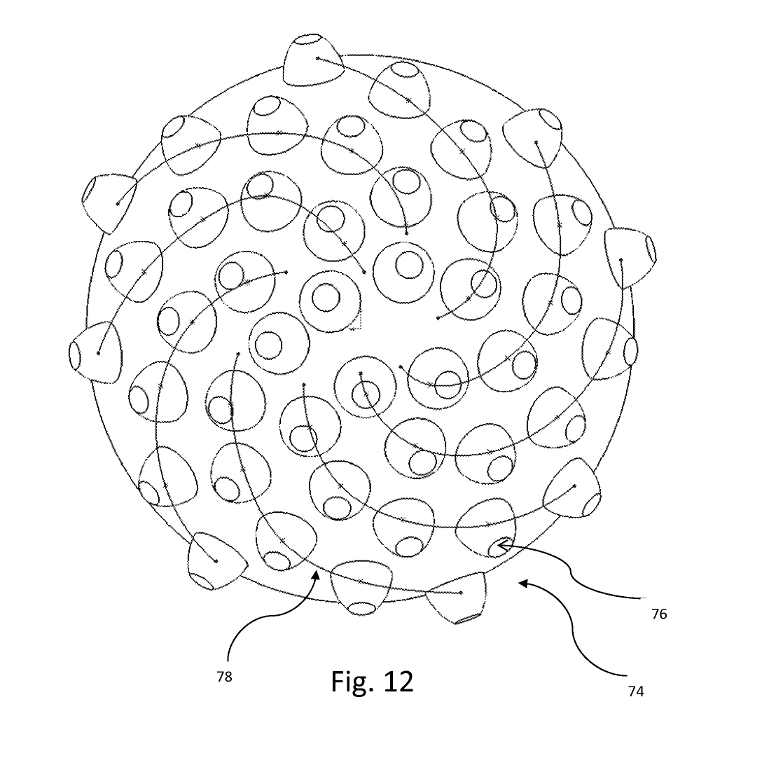

FIG. 11 is a top plan view of a power transfer body 74 according to the embodiment of FIG. 10. Power transfer body 74 of FIG. 11 may comprise either a power input body or a power output body. An exemplary array or distribution of projections 76 is illustrated in top plan view in FIG. 11. FIG. 12 is a top plan view of a power transfer body 74 according to the embodiment of FIG. 10, and further depicting a path 78 or trajectory along which projections 76 are provided. Ash shown, path 78 generally follows the aforementioned pattern or fermat's spiral formation.

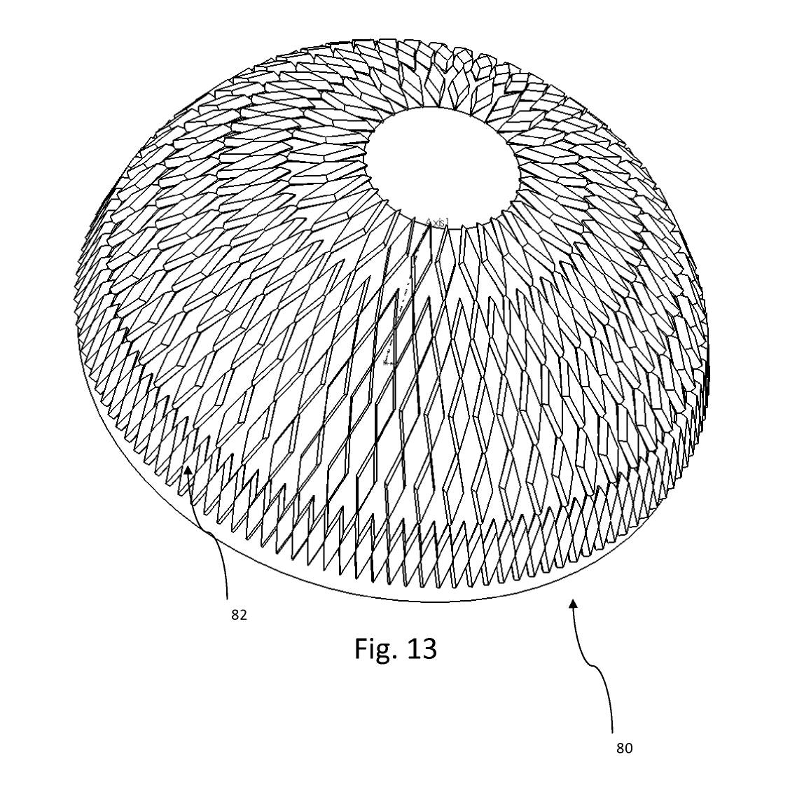

FIG. 13 depicts a power transfer body 80 according to an alternative embodiment with a predetermined surface texture 82, the surface texture comprising a plurality of diamond-shaped protrusions, which may alternatively be provided as diamond-shaped indentations. Peripheral edges and/or top surfaces of the protrusions interface with a second power transfer body to accomplish power, torque, and angular velocity transmission between the two bodies.

The foregoing discussion has been presented for purposes of illustration and description and is not intended to limit the disclosure to the form or forms disclosed herein. Further, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A continuously variable transmission mechanism comprising:
a first rotary power transfer member for receiving an input power from an input, the first power transfer member being rotated about a first axis by the input power;
a second rotary power transfer member for receiving power from the first rotary power transfer member and transmitting the power to an output;
the first rotary power transfer member and second rotary power transfer member being in frictional torque-transmitting contact with one another;
wherein an angular velocity of the output varies from an angular velocity of the input as a function of the orientation of the first power transfer member with respect to the second power transfer member, and wherein the first power transfer member is rotatable about a second axis, the second axis being substantially perpendicular to the first axis.

2. The continuously variable transmission mechanism of claim 1, wherein the first rotary power transfer member comprises a hemispherical member.

3. The continuously variable transmission mechanism of claim 1, wherein the first rotary power transfer member and the second rotary power transfer member comprise hemispherical members of substantially the same dimension.

4. The continuously variable transmission mechanism of claim 1, wherein the second rotary power transfer member comprises a substantially cylindrical body.

5. The continuously variable transmission mechanism of claim 1, wherein the output comprises a drive shaft.

6. The continuously variable transmission mechanism of claim 1, wherein the first power transfer member is rotatable about the second axis by selective user-manipulation of a shift-lever.

7. The continuously variable transmission mechanism of claim 1, wherein the surface of at least one of the first power transfer member and the second power transfer member comprise progressive ribs protruding therefrom.

8. The continuously variable transmission mechanism of claim 1, wherein the first power transfer member is rotatable across a range of at least approximately 180 degrees.

9. The continuously variable transmission mechanism of claim 1, wherein at least one of the first rotary power transfer member and the second rotary power transfer member comprise a plurality of discrete projections arranged on a surface of the at least one of the first rotary power transfer member and the second rotary power transfer member.

10. A continuously variable transmission mechanism comprising:
a first rotary power transfer member for receiving an input power from an input, the first power transfer member being rotated about a first axis by the input power;
a second rotary power transfer member for receiving power from the first rotary power transfer member and transmitting the power to an output;
the first rotary power transfer member and second rotary power transfer member being in torque-transmitting contact with one another;
wherein an angular velocity of the output varies from an angular velocity of the input as a function of the orientation of the first power transfer member with respect to the second power transfer member, and wherein the first power transfer member is rotatable about a second axis, the second axis being substantially perpendicular to the first axis, the first and second axis comprising a point of intersection located approximately at a geometric center of the first rotary power transfer member.

11. The mechanism of claim 10, wherein at least one of the first rotary power transfer member and the second rotary power transfer member comprises a plurality of discrete surface projections for engaging a portion of a complementary power transfer member.

12. The continuously variable transmission mechanism of claim 10, wherein the first rotary power transfer member comprises a hemispherical member.

13. The continuously variable transmission mechanism of claim 10, wherein the first rotary power transfer member and the second rotary power transfer member comprise hemispherical members of substantially the same dimension.

14. The continuously variable transmission mechanism of claim 10, wherein the second rotary power transfer member comprises a substantially cylindrical body.

15. The continuously variable transmission mechanism of claim 10, wherein the output comprises a drive shaft.

16. The continuously variable transmission mechanism of claim 10, wherein the first power transfer member is rotatable about the second axis by selective user-manipulation of a shift-lever.

17. The continuously variable transmission mechanism of claim 10, wherein the surface of at least one of the first power transfer member and the second power transfer member comprise progressive ribs protruding therefrom.

18. The continuously variable transmission mechanism of claim 10, wherein the first power transfer member is rotatable across a range of at least approximately 180 degrees.

19. A continuously variable transmission mechanism comprising:
a first rotary power transfer member comprising a curvilinear outer surface;
a second rotary power transfer member comprising a curvilinear outer surface;
the first rotary power transfer member and second rotary power transfer member being in articulating and force transmitting contact with one another;
wherein an angular velocity of the second rotary power transfer member varies from an angular velocity of the first rotary power transfer member as a function of the orientation of the first power transfer member; and
wherein the first power transfer member is rotatable about a first axis, the first axis comprising a power transmission axis, and the orientation of the first power transfer member is altered by rotation about a second axis, the second axis being substantially perpendicular to the first axis.

20. The mechanism of claim 19, wherein the first rotary power transfer member comprises a spherical outer surface of substantially constant radius.
